(19) United States
(12) Patent Application Publication
(10) Pub. No.: US 2007/0027222 A1
(43) Pub. Date: Feb. 1, 2007

(54) Monodisperse cation exchangers

(75) Inventors: Pierre VanHoorne, Monheim (DE); Wolfgang Podszun, Koln (DE); Reinhold Klipper, Koln (DE); Olaf Halle, Koln (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/489,084

(22) Filed: Jul. 19, 2006

(30) Foreign Application Priority Data
Jul. 29, 2005 (DE) 10 2005 035 616.8

(51) Int. Cl. C08J 5/20

(52) U.S. Cl. 521/25

(57) ABSTRACT

The present invention relates to a process for producing novel monodisperse weakly acidic cation exchangers of the poly(meth)acrylic acid type, the ion exchangers themselves, and also use thereof.

The present invention relates to a process for preparing monodisperse weakly acidic cation exchangers of the poly(meth)acrylic acid type, these cation exchangers, and also uses thereof.

### BACKGROUND OF THE INVENTION

From the prior art, heterodisperse cation exchangers of the poly(meth)acrylic acid type are already known. These are a class of cation exchangers which can be used in practice for numerous different applications.

An important area of use of heterodisperse cation exchangers of the poly(meth)acrylic acid type is in water treatment technology, in which it is possible to remove polyvalent cations, for example calcium, magnesium, lead or copper, but also carbonate anions.

A known process for preparing heterodisperse cation exchangers of the poly(meth)acrylic acid type is hydrolysis of crosslinked bead polymers of (meth)acrylic monomers using acids or alkalis according to DE 10 322 441 A1 (US 2005 09 0621), DD 67583 or U.S. Pat. No. 5,369,132.

The crosslinked (meth)acrylic ester or (meth)acrylonitrile resin bead polymers used for the hydrolysis are prepared in the prior art as gel-type or macroporous resins. They are prepared in mixed polymerization by the suspension polymerization process. This produces heterodisperse bead polymers having a broad particle size distribution in the range of approximately 0.2 mm to approximately 1.2 mm.

The heterodisperse cation exchangers of the poly(meth)acrylic acid type, depending on the charged form of the resin, that is to say depending on the type of counterion, exhibit differing resin volumes. In the conversion from the free acid form to the sodium form, the resin swells markedly. Conversely, on conversion from the sodium form to the free acid form, it shrinks. In the industrial use of these heterodisperse cation exchangers of the poly(meth)acrylic acid type, therefore, each charging and regeneration is associated with swelling or shrinkage. In the course of long-term use, however, these heterodisperse cation exchangers are regenerated several hundred times. The shrinking and swelling operations occurring as this is done stress the bead stability so greatly that a fraction of the beads acquire cracks, finally even fracturing. Fragments are produced which lead to blockages in the service apparatus, the columns, impede flow, which in turn leads to an increased pressure drop. In addition, the fragments contaminate the medium to be treated, preferably water, and thus reduce the quality of the medium or the water.

The flow of water through a column packed with beads, however, is impeded not only by resin fragments, but also by fine polymer beads. A rise in the pressure drop occurs. Owing to the particle size distribution, however, a heterodisperse cation exchanger of the poly(meth)acrylic acid type contains beads of differing diameter. The presence of fine beads thus additionally increases the pressure drop.

After completion of charging of cation exchangers of the poly(meth)acrylic acid type with cations, the resin is regenerated with dilute hydrochloric acid in order to be ready for new charging. Hydrochloric acid residues are washed out of the resin with water. During production of the resins a low conductivity of the effluent water (washwater) from the resin is desired, since otherwise contaminated water is present. The aim is to achieve low conductivities using small amounts of washwater.

To decrease the pressure drop and to improve the extractability, therefore, the use of narrow particle size distribution cation exchangers of the poly(meth)acrylic acid type is desirable.

Narrow particle size distribution cation exchangers of the poly(meth)acrylic acid type in the range of 30 to 500 μm are customarily obtained by fractionating cation exchangers of the poly(meth)acrylic acid type having a wide particle size distribution. A disadvantage in this process is that with increasing monodispersity the yield of the desired target fraction in the fractionation decreases greatly. The mechanical and osmotic stability of the cation exchangers thus obtained is not improved either.

DE 10 237 601 A1 (=AU 2003 255 363 A1) discloses monodisperse gel-type ion exchangers having a diameter of up to 500 μm which are prepared from monodisperse gel-type bead polymers which contain 50 to 99.9% by weight of styrene and, as comonomers, copolymerizable compounds, such as e.g. methyl methacrylate, ethyl methacrylate, ethyl acrylate, hydroxyethyl methacrylate or acrylonitrile. In the process according to DE 10 237 601 A1, use is made of uncrosslinked seed polymers. After hydrolysis of the monodisperse gel-type bead polymers, cation exchangers are obtainable which have functional groups of the poly(meth)acrylic acid type. Owing to the high content of non-functional styrene, the total capacity (number of functional groups per unit volume of resin in eq./litre) of such cation exchangers is limited and insufficient for most applications.

Starting from the prior art, the object of the present invention was to provide cation exchangers of the poly(meth)acrylic acid type having high mechanical stability and also osmotic stability of the beads, low pressure drop of the bead bed in use and also low washwater consumption of the cation exchanger itself.

### SUMMARY OF THE INVENTION

The present invention and solution of this object therefore relate to a process for preparing monodisperse cation exchangers of the poly(meth)acrylic acid type, wherein
a) a monodisperse, bead-type crosslinked bead polymer is prepared as seed,
b) this monodisperse crosslinked bead polymer is admixed with (meth)acrylic monomers, suitable crosslinkers and initiators, the seed polymer swelling owing to the (meth)acrylic monomers,
c) the swollen (meth)acrylic monomers are polymerized at elevated temperature,
d) if appropriate steps b) and c) are repeated once or several times and
e) the resultant monodisperse, crosslinked (meth)acrylic bead polymer is hydrolysed with acids or alkalis to give a crosslinked, monodisperse bead polymer of the (meth)acrylic acid type.

As a measure of the width of the particle size distribution of the inventive monodisperse cation exchangers of the (meth)acrylic acid type, the ratio of the 90% value (Ø(90)) and the 10% value (Ø(10)) of the volume distribution is formed. The 90% value (Ø(90)) is the diameter which 90% of the particles fall below. Correspondingly, 10% of the particles fall below the diameter of the 10% value (Ø(10)). Monodisperse particle size distributions in the context of the present application denote Ø(90)/Ø(10)≦1.5, preferably Ø(90)/Ø(10)≦1.25.

Cation exchangers of the poly(meth)acrylic acid type are weakly acidic and contain polymerized units of acrylic acid or methacrylic acid.

The monodisperse crosslinked seed bead polymers prepared in process step a) can be produced by various methods.

A simple method for producing monodisperse bead polymers is fractionating bead polymers having a heterodisperse distribution. This fractionation can be performed, for example, by sieving, air classification or by classifying or fractionating sedimentation.

Preference is given to methods in which the monodispersity is established in the production process itself. In the atomization process, or in “jetting”, a monomer mixture consisting of one or more different vinyl monomers and also one or more crosslinkers, one or more initiators is sprayed into a liquid which is essentially immiscible with the monomer mixture, droplets of uniform particle size being formed. By employing a longitudinal oscillation of suitable frequency, the formation of monodisperse droplets can be supported. The oscillation excitation can be achieved by the action of periodic pressure fluctuations, such as sound waves. Further details on oscillation excitation are described in EP-A 0 046 535 (=U.S. Pat. No. 4,427,794).

In a particular embodiment of the present invention, the monodisperse droplets produced by atomization and oscillation excitation are microencapsulated. In this manner it is possible to produce bead polymers having particularly high monodispersity.

For microencapsulation of the monomer droplets, the materials known for use as complex coacervates come into consideration, in particular polyesters, natural or synthetic polyamides, polyurethanes, polyureas.

As a natural polyamide, gelatin, for example, is particularly highly suitable. This is used in particular as a coacervate or complex coacervate. Gelatin-containing complex coacervates within the context of the invention are taken to mean, especially, combinations of gelatin with synthetic polyelectrolytes. Suitable synthetic polyelectrolytes are copolymers having incorporated units of, for example, maleic acid, acrylic acid, methacrylic acid, acrylamide or methacrylamide. Particularly preferably, acrylic acid or acrylamide is used. Gelatin-containing capsules can be hardened using conventional hardening agents such as, for example, formaldehyde or glutaraldehyde. The encapsulation of monomer droplets via gelatin, gelatin-containing coacervates and gelatin-containing complex coacervates is described in detail in EP 0 046 535 B1. The methods of encapsulation using synthetic polymers are known. Phase boundary condensation is highly suitable, for example, in which a reactive component (for example an isocyanate or an acid chloride) dissolved in the monomer droplet is reacted with a second reactive component (for example an amine) dissolved in the aqueous phase.

Polymerization of the monodisperse droplets produced from the monomer mixture can be started in a column, and subsequently completed in a polymerization vessel, monodisperse bead polymers being produced. This method is described in U.S. Pat. No. 3,922,255.

The production of monodisperse, crosslinked bead polymers which are suitable as seed for the inventive process can also proceed by the seed-feed process starting from a monodisperse starting polymer obtained by dispersion polymerization.

In this case, in a first step, a non-crosslinked monodisperse starting polymer in the range of 0.5 to 20 μm is produced by dispersion polymerization in a nonaqueous solvent. This small starting polymer is then dispersed in water and swollen to form a bead polymer of the desired diameter by repeated addition of monomer, initiator and if appropriate crosslinker in the form of an aqueous emulsion, swelling the monomer mixture into the bead polymer and subsequent polymerization. In this case the monodispersity of the starting polymer is transferred to the desired bead polymer. Monodisperse bead polymers according to this process are virtually exclusively styrene-containing and are described, for example, in EP-A 0 448 391, EP-A 0 288 006 and DE 10 237 601 A1, the contents of which are hereby incorporated by the present application.

Further embodiments for the production of monodisperse, crosslinked bead polymers by the seed-feed process are described, for example, in U.S. Pat. No. 4,444,961, EP 46 535 B1, U.S. Pat. No. 4,419,245, WO 93/12167 or EP 101 943 B1, the contents of which are hereby incorporated by the present application.

The seed-bead polymers can essentially consist of (meth)acrylic esters.

(Meth)acrylic esters are taken to mean the esters of acrylic acid and methacrylic acid. Those which may be mentioned are ethyl acrylate, methyl acrylate, n-butyl acrylate, t-butyl acrylate, 2-ethylhexyl acrylate, benzyl acrylate, ethyl methacrylate, methyl methacrylat, n-butyl methacrylate, t-butyl methacrylate and 2-ethylhexyl methacrylate. Preference is given to methyl methacrylate and methyl acrylate.

(Meth)acrylate bead polymers suitable as seed contain 0.05 to 8% by weight, preferably 0.1 to 5% by weight, of crosslinker. Suitable crosslinkers for the seed-bead polymers are multifunctional ethylenically unsaturated compounds, such as, for example, butadiene, isoprene, divinylbenzene, divinyltoluene, trivinylbenzene, divinylnaphthalene, trivinylnaphthalene, divinylcyclohexane, trivinylcyclohexane, triallyl cyanurate, triallylamine, 1,7-octadiene, 1,5-hexadiene, cyclopentadiene, norbomadiene, diethylene glycol divinyl ether, triethylene glycol divinyl ether, tetraethylene glycol divinyl ether, butanediol divinyl ether, ethylene glycol divinyl ether, cyclohexanedimethanol divinyl ether, hexanediol divinyl ether and trimethylolpropanetrivinyl ether. Divinylbenzene is suitable in many cases. Commercial divinylbenzene qualities which, in addition to the isomers of divinylbenzene, also contain ethylvinylbenzene, are sufficient. Mixtures of different crosslinkers, e.g. mixtures of divinylbenzene and divinylether, can also be used.

It has been found that styrene copolymers, provided they are crosslinked to a low extent, are highly suitable as seed-bead polymers. Low degree of crosslinking means that the copolymer contains 0.05 to 5% by weight, preferably 0.1 to 1% by weight, of crosslinker.

In process step b), the seed-bead polymer is admixed with (meth)acrylic monomers, suitable crosslinkers and initiators.

(Meth)acrylic monomers in the present context are taken to mean (meth)acrylic esters, (meth)acrylamides, (meth)acrylonitrile, acrylic acid, methacrylic acid, acryloyl chloride and methacryloyl chloride. (Meth)acrylic esters are the compounds described in process step a). (Meth)acrylamides are taken to mean substituted and unsubstituted amides of acrylic acid and methacrylic acid. Those which may be mentioned are acrylamide, methacrylamide, dimethylacrylamide, dimethylmethacrylamide, diethylacrylamide, diethylmethacrylamide. Preference is given to acrylamide and methacrylamide. (Meth)acrylonitrile comprises acrylonitrile and methacrylonitrile. Particularly preferably, methyl acrylate is used in the context of the present invention.

Suitable crosslinkers in the context of the present invention are the compounds already described in process step a).

The fraction of crosslinker in the monomer mixture is 2 to 50% by weight, preferably 4 to 20% by weight, particularly preferably 4 to 10% by weight.

Initiators which are suitable for the inventive process are, for example, peroxy compounds such as dibenzoyl peroxide, dilauroyl peroxide, bis(p-chlorobenzoyl) peroxide, dicyclohexyl peroxy-dicarbonate, tert-butyl peroctoate, tert-butyl peroxy-2-ethylhexanoate, 2,5-bis(2-ethyl-hexanoylperoxy)-2,5-dimethylhexane or tert-amylperoxy-2-ethylhexane, and also azo compounds such as 2,2′-azobis(isobutyronitrile) or 2,2′-azobis(2-methylisobutyronitrile).

The initiators are generally used in amounts of 0.05 to 2.5% by weight, preferably 0.1 to 1.5% by weight, based on the monomer mixture.

As further additives in the monomer mixture of (meth)acrylic monomers, suitable crosslinkers and initiators, use can be made of porogens in order to generate a macroporous structure in the bead-type polymer. Organic solvents which mix with the (meth)acrylic monomers are suitable for this. Examples which may be mentioned are hexane, cyclohexane, octane, isooctane, isododecane, methyl ethyl ketone, methyl isobutyl ketone, butanol or octanol and their isomers. Suitable porogens are also described in DE 1 045 102, DE 1 113 570 and U.S. Pat. No. 4,382,124.

The porogen fraction used for the synthesis of inventive macroporous cation exchangers is 3 to 40% by weight, preferably 5 to 20% by weight, based on the monomer mixture.

The terms macroporous and gel-type have been described in detail in the specialist literature, for example in Seidl, Malinsky, Dusek, Heitz, Adv. Polymer Sci., Vol. 5 pages 113 to 213 (1967).

In process step c), the monodisperse (meth)acrylic bead polymers are produced at elevated temperature by polymerization of the corresponding monomer mixture in an aqueous phase.

In this case the aqueous phase can contain a dissolved polymerization inhibitor. Inhibitors which come into consideration are not only inorganic but also organic substances. Examples of inorganic inhibitors are nitrogen compounds, such as hydroxylamine, hydrazine, sodium nitrite and potassium nitrite, salts of phosphorous acid, such as sodium hydrogenphosphite, and sulphur compounds, such as sodium dithionite, sodium thiosulphate, sodium sulphite, sodium bisulphite, sodium thiocyanate or ammonium thiocyanate. Examples of organic inhibitors are phenolic compounds, such as hydroquinone, hydroquinone monomethyl ether, resorcinol, catechol, tert-butylcatechol, pyrogallol or condensation products of phenols with aldehydes. Other suitable organic inhibitors are nitrogen compounds. These include hydroxylamine derivatives, for example N,N-diethylhydroxylamine, N-isopropylhydroxylamine and sulphonated or carboxylated N-alkylhydroxylamine derivatives or N,N-dialkylhydroxylamine derivatives, hydrazine derivatives, for example N,N-hydrazinodiacetic acid, nitroso compounds, for example N-nitrosophenylhydroxylamine, N-nitrosophenylhydroxylamine ammonium salt or N-nitrosophenylhydroxylamine aluminium salt. The concentration of the inhibitor is 5 to 1000 ppm (based on the aqueous phase), preferably 10 to 500 ppm, particularly preferably 10 to 250 ppm.

The monomer mixture is polymerized optionally in the presence of one or more protective colloids in the aqueous phase. Suitable protective colloids are natural or synthetic water-soluble polymers, for example gelatin, starch, polyvinyl alcohol, polyvinylpyrrolidone, polyacrylic acid, polymethacrylic acid, or copolymers of (meth)acrylic acid and (meth)acrylic esters. Very highly suitable protective colloids are also cellulose derivatives, in particular cellulose esters and cellulose ethers, such as carboxymethylcellulose, methylhydroxyethylcellulose, methylhydroxypropylcellulose and hydroxyethylcellulose. Gelatin and methylhydroxyethyl cellulose are particularly highly suitable. The amount of protective colloids used is generally 0.05 to 1% by weight, based on the aqueous phase, preferably 0.05 to 0.5% by weight.

The polymerization to give the monodisperse crosslinked (meth)acrylic polymer can optionally also be carried out in the presence of a buffer system. Preference is given to buffer systems which set the pH of the aqueous phase at the start of polymerization to between 14 and 6, preferably between 13 and 8. Under these conditions protective colloids containing carboxylic acid groups are present wholly or partly as salts. In this manner the action of the protective colloids is favourably influenced. Particularly highly suitable buffer systems comprise phosphate salts or borate salts. The terms phosphate and borate in the context of the invention also include the condensation products of ortho forms of corresponding acids and salts. The concentration of phosphate or borate in the aqueous phase is 0.5 to 500 mmol/l, preferably 2.5 to 100 mmol/l.

The stirrer speed in the polymerization is less critical and, in contrast to the conventional bead polymerization, has barely any effect on the particle size. Low stirrer speeds are employed which are sufficient to keep the suspended monomer droplets in suspension and to support the removal of the heat of polymerization. For this task, various stirrer types can be used. Particularly suitable types are gate stirrers having an axial action.

The volumetric ratio of the sum of seed-bead polymer and monomer mixture to aqueous phase is 1:0.75 to 1:20, preferably 1:1 to 1:6.

The polymerization temperature depends on the decomposition temperature of the initiator used. It is generally between 50 and 180° C., preferably between 55 and 130° C. The polymerization takes 0.5 h to a few hours. It has proven useful to employ a temperature programme in which the polymerization is started at low temperature, for example 60° C., and the reaction temperature is increased with advancing conversion of polymerization. In this manner, for example, the demand for a safe reaction and a high degree of polymerization can be fulfilled very efficiently. After polymerization the bead polymer is isolated with conventional methods, for example by filtration or decanting, and, if appropriate, washed.

A particularly advantageous embodiment of the present invention is a multistage feed process corresponding to process step d). In this process the (meth)acrylic polymer is produced in a plurality of individual steps. For example, a monodisperse bead-type polymer suitable as seed based on stryrene-divinylbenzene is produced, this is fed with a first mixture of (meth)acrylic monomers, crosslinker and initiator and polymerized, the copolymer I being obtained. Copolymer I is fed with further monomer mixture of (meth)acrylic monomers, crosslinker and initiator and polymerized, the inventive monodisperse crosslinked (meth)acrylic bead polymer being formed.

The mean particle size of the crosslinked (meth)acrylic bead polymers from process step c) or d) is 10-1000 μm, preferably 100-1000 μm, particularly preferably 200 to 800 μm.

In process step e) of the inventive process, the monodisperse crosslinked (meth)acrylic bead polymer from process step c) or d) is hydrolysed.

Suitable hydrolysis agents in this process are strong bases or strong acids, for example sodium hydroxide solution or sulphuric acid. The concentration of the hydrolysis agent is generally 5 to 50% by weight. The hydrolysis preferably proceeds at temperatures of 50° C. to 200° C., particularly preferably 80° C. to 180° C. The duration of the hydrolysis is preferably 1 to 24 h, particularly preferably 1 to 12 h.

After hydrolysis the reaction mixture of hydrolysis product and residual hydrolysis agent is cooled to room temperature and first diluted with water and washed.

When sodium hydroxide solution is used as hydrolysis agent, the weakly acidic cation exchanger arises in the sodium form. For some applications it is expedient to convert the cation exchanger from the sodium form to the acid form. This exchange is done with sulphuric acid of a concentration of 5 to 50% by weight, preferably 10 to 20% by weight.

If desired, the inventive weakly acidic cation exchanger obtained, for purification, is treated with deionized water at temperatures of 70 to 145° C., preferably 105 to 130° C.

The present invention also relates to the monodisperse cation exchanger of the poly(meth)acrylic acid type obtainable by
a) preparing a monodisperse, bead-type crosslinked bead polymer as seed,
b) admixing this monodisperse crosslinked bead polymer with (meth)acrylic monomers, suitable crosslinkers and initiators, the seed polymer swelling owing to the (meth)acrylic monomers,
c) polymerizing the swollen (meth)acrylic monomers at elevated temperature,
d) if appropriate repeating steps b) and c) once or several times and
e) hydrolysing the resultant, monodisperse, crosslinked (meth)acrylic bead polymer with acids or alkalis to give a crosslinked monodisperse (meth)acrylic acid-type bead polymer.

The inventive monodisperse cation exchangers have a particular osmotic and mechanical stability. Owing to these beneficial properties and the monodispersity, these cation exchangers are suitable for numerous applications.

The present invention therefore also relates to the use of the inventive monodisperse cation exchanger of the poly(meth)acrylic acid type
for removing cations, dye particles or organic components from aqueous or organic solutions,
for softening in the neutral exchange of aqueous or organic solutions,
for purifying and workup of waters of the chemicals industry, the electronics industry and from power stations,
for separating off and purifying biologically active components, such as e.g. antibiotics, enzymes, peptides and nucleic acids from their solutions, for example from reaction mixtures and from fermentation broths.

In addition, the inventive cation exchangers can be used in combination with gel-type and/or macroporous anion exchangers for demineralizing aqueous solutions and/or condensates, in particular in drinking water treatment.

The present invention also relates to
processes for purifying and workup of waters of the chemicals industry, the electronics industry and from power stations,
processes for removing cations, dye particles or organic components from aqueous or organic solutions,
processes for softening in the neutral exchange of aqueous or organic solutions, processes for separating off and purifying biologically active components, such as e.g. antibiotics, enzymes, peptides and nucleic acids from their solutions, for example from reaction mixtures and from fermentation broths
   using the inventive cation exchangers of the poly(meth)acrylic acid type.

### EXAMPLE 1

Process Steps a-c) Production of a Copolymer I

An aqueous solution of 3.6 g of boric acid and 1.0 g of sodium hydroxide in 1218 g of deionized water was placed in a 41 glass reactor. 264.7 g of monodisperse microencapsulated seed polymer containing 99.38% by weight of styrene, 0.5% by weight of divinylbenzene and 0.12% by weight of ethylstyrene was added. Divinylbenzene was used as commercially conventional isomer mixture of 80.6% by weight of divinylbenzene and 19.4% by weight of ethylstyrene were added. The seed polymer was prepared according to EP 0 046 535 B1 and the capsule wall of the seed polymer consisted of a formaldehyde-hardened complex coacervate of gelatin and an acrylamide/acrylic acid copolymer. The mean particle size of the seed polymer was 244 μm, 97% by volume of the particles were in the range from 220 to 268 μm. The mixture was stirred at a stirrer speed of 220 rpm. In the course of 30 minutes, a mixture of 605.1 g of methyl acrylate, 30.2 g of diethylene glycol divinyl ether and 3.39 g of dibenzoyl peroxide (75% strength by weight) was added. The polymerization mixture was stirred for 2 hours at room temperature, the gas space being purged with nitrogen. Thereafter a solution of 2.7 g of methylhydroxyethylcellulose in 132.3 g of deionized water was added. The batch was heated to 63° C. in the course of 75 minutes and kept at this temperature for 5 hours. It was then heated to 95° C. in the course of 60 minutes and stirred for a further 120 minutes at this temperature. The batch, after cooling, was washed with deionized water through a 125 μm screen and then dried for 18 hours at 80° C. in a drying cabinet. This produced 713 g of a bead-type copolymer I having a mean particle size of 335 μm and a Ø(90)/Ø(10) value of 1.44.

Process Step d) Production of a Copolymer II

An aqueous solution of 1.08 g of boric acid and 0.34 g of sodium hydroxide in 917 g of deionized water was placed in a 4 1 glass reactor. 288.7 g of copolymer I was added. The mixture was stirred at a stirrer speed of 220 rpm. In the course of 30 minutes, a mixture of 439.6 g of methyl acrylate, 21.9 g of diethylene glycol divinyl ether and 2.46 g of dibenzoyl peroxide (75% strength by weight) was added. The mixture was stirred for 2 hours at room temperature, the gas space being purged with nitrogen. Thereafter, a solution of 1.83 g of methylhydroxyethylcellulose in 89.8 g of deionized water was added. The batch was heated to 60° C. in the course of 75 minutes and kept at this temperature for 5 hours. Subsequently, it was heated to 95° C. in the course of 60 minutes and stirred at this temperature for a further 120 minutes. The batch, after cooling, was washed with deionized water through a 125 μm screen and then dried for 18 hours at 80° C. in a drying cabinet. 594 g of a bead-type copolymer II having a mean particle size of 470 μm and a Ø(90)/Ø(10) value of 1.46 was produced.

Process Step e) Hydrolysis of Copolymer II

Saponification of the monodisperse, crosslinked, methyl acrylate copolymer II from process steps a-d) using sodium hydroxide

807 g of deionized water containing 2104 g of 50% strength by weight NaOH solution were charged at 200 rpm in a 4 liter flat-flange vessel having a gate stirrer, distillation bridge, temperature sensor and also thermostat and temperature recorder. 245 g of copolymer II were introduced in portions with stirring. The mixture was heated in the course of 2.5 hours to reflux. Then, the mixture was stirred under reflux for 5 hours and 600 ml of mixture of methanol and water were distilled. Thereafter, the mixture was cooled to room temperature. The saponified copolymer II was washed with deionized water in a column until the pH was neutral. This produced 1500 ml of monodisperse weakly acidic cation exchanger I in the sodium form.

Ion exchange of the weakly acidic cation exchanger 1

In a column, 1500 ml of the moist, monodisperse, weakly acidic cation exchanger 1 in the sodium form was eluted with 1800 ml of 6% strength by weight sulphuric acid and subsequently washed with deionized water until the pH was neutral. 800 ml of monodisperse, weakly acidic cation exchanger 1 in the acid form having a water content of 62.6% by weight was produced.

The mean particle size was 560 μm and the Ø(90)/Ø(l0) value was 1.46.

Total capacity of the resin: 3.53 mol/l

### EXAMPLE 2

Process Step a) Production of Monodisperse, Weakly Crosslinked Seed Polymer according to DE-A 10 237 601.

i) Production of an Uncrosslinked Seed Polymer by Dispersion Polymerization

24 kg of n-butanol and 1800 g of polyvinylpyrrolidone (Luviskol® K30) were stirred for 60 min in a 50 liter VA steel reactor, a homogeneous solution being obtained. The reactor was evacuated 3 times and subsequently flooded with nitrogen and 3000 g of styrene were added in the course of a few minutes with further stirring at 120 rpm. The reactor was heated to 80° C. When a temperature of 71° C. was reached, a solution, heated to 40° C., of 30 g of azodiisobutyronitrile and 1170 g of n-butanol was added all at once. The stirrer speed was increased for 2 min to 180 rpm and thereafter set to 90 rpm. The reaction mixture was kept at 80° C. for 20 h. Thereafter the reaction mixture was cooled to room temperature, the resultant polymer was isolated by centrifugation, washed twice with methanol and twice with water. This produced 7262 g of an aqueous dispersion of the seed polymer i) having a solids fraction of 15.7% by weight. The particle size was 2.8 μm, Ø(90)/Ø(10) was 1.29.

ii) Production of an Uncrosslinked Seed Polymer ii)

A finely divided emulsion I was produced using an Ultraturrax (3 min. at 13 500 rpm) in a plastic container from 5915 g of styrene, 182.2 g of 75% strength by weight dibenzoyl peroxide, 4550 g of water, 65.9 g of ethoxylated nonylphenol (Arkopal® N060), 9.5 g of isooctyl sulphosuccinate sodium salt, 36 g of 3,3″,3″5,540 ,5″-hexa-tert-butyl-α,α′,α″-(mesitylene-2,4,6-triyl)tri-p-cresol (inhibitor Irganox® 1330) and 4.6 g of resorcinol. A solution of 182 g of methylhydroxyethylcellulose, 22 609 g of deionized water, 4646 g of aqueous dispersion of the seed polymer i) and 1365 g of methanol were charged into a 50 litre VA steel reactor which was purged with a nitrogen stream of 20 l/h. At room temperature, with stirring, the finely divided emulsion I was pumped in at constant rate in the course of 3 hours. The batch was then left at room temperature for 1 hour, heated to 80° C. in the course of one hour and polymerized at 80° C. for 9 hours. Thereafter, the reaction mixture was cooled to room temperature, the resultant polymer was isolated by centrifugation, washed twice with methanol and twice with water and dispersed in water. This produced 6670 g of an aqueous dispersion of the seed polymer ii) having a solids fraction of 35.7% by weight. The particle size was 5.2 μm, Ø(90)/Ø(10) was 1.33.

Production of the seed polymers iii) to viii)

Step ii) was Repeated, but the Following were Used:
in step iii) a dispersion of the seed polymer ii);
in step iv) a dispersion of the seed polymer iii).

From step v) all batches were reduced to 1/20th of the amount and carried out in a 4 liter glass reactor.
In step v), use was made of a dispersion of the seed polymer iv) and an emulsion produced from 300 g of styrene and 1.14 g of 80% strength by weight divinylbenzene. Neither resorcinol nor methanol was added and the post-stirring time at room temperature was 13 h instead of 1 h;
in step vi), step v) was repeated, but a dispersion of the seed polymer v) was used;
in step vii), step vi) was repeated, but use was made of a dispersion of the seed polymer vi) and an emulsion produced using a mixture of 200 g of styrene, 100 g of methyl acrylate, 0.38 g of diethylene glycol divinyl ether (DEGDVE) and 0.76 g of 80% strength by weight divinylbenzene, and the mixture was post-stirred at room temperature for 14 h;
in step viii), step vii) was repeated, but use was made of a dispersion of the seed polymer vii) and an emulsion produced using a mixture of 100 g of styrene, 200 g of methyl acrylate, 0.76 g of diethylene glycol divinyl ether (DEGDVE) and 0.38 g of 80% strength by weight divinylbenzene. The emulsion was kept at 0 to 5° C. during production and metering, and the batch, after the end of metering, was kept at room temperature for 14 h and heated to 80° C. for 7 h.

The resultant bead polymers are listed in the table below:

| | | Particle size | |
|---|---|---|---|
| Seed polymer | Monomers | (μm) | Ø(90)/Ø(10) |
| i) | 100% styrene | 2.8 | 1.29 |
| ii) | 100% styrene | 5.2 | 1.33 |
| iii) | 100% styrene | 9.5 | n.d. |
| iv) | 100% styrene | 19 | n.d. |
| v) | 99.62% styrene | 38 | n.d. |
| | 0.3% divinylbenzene | | |
| | 0.08% ethylvinylbenzene | | |
| vi) | 99.62% styrene | 84 | n.d. |
| | 0.3% divinylbenzene | | |
| | 0.08% ethylvinylbenzene | | |
| vii) | 66.7% styrene | 171 | 1.46 |
| | 33.3% methyl acrylate | | |
| | 0.2% divinylbenzene | | |
| | 0.15% DEGDVE | | |
| viii) | 33.3% styrene | 335 | 1.46 |
| | 66.7% methyl acrylate | | |
| | 0.1% divinylbenzene | | |
| | 0.3% DEGDVE | | |

Process Steps b-c)

Production of a Copolymer III

In a plastic container, a finely divided emulsion II was produced at a temperature between 0 and 5° C. from 285 g of methyl acrylate, 15 g of diethylene glycol divinyl ether, 0.03 g of hydroquinone, 10 g of dibenzoyl peroxide (75% by weight), 500 g of water, 3.62 g of ethoxylated nonylphenol (Arkopal® N060), 0.50 g of isooctyl sulphosuccinate sodium salt and 2 g of 3,3′,3″5,5′,5″-hexa-tert-butyl-alpha,alpha′,alpha″-(mesitylene-2,4,6-triyl)tri-p-cresol (inhibitor Irganox® 1330) using an Ultraturrax (3 min at 10 000 rpm).

10 g of methylhydroxyethylcellulose in 2245 g of deionized water were charged in a 4 litre three-necked flask which was purged with a nitrogen stream of 20 l/h, and stirred for 20 h at 70° C. After cooling, 113.6 g of a 35.2% strength by weight aqueous dispersion of the seed polymer viii) and 786.4 g of deionized water were charged. At room temperature, under stirring, the finely divided emulsion II kept between 0 and 5° C. was pumped in at a constant rate in the course of 30 minutes. The batch was then heated to 80° C. in the course of 30 minutes and stirred at this temperature for 5 hours. Thereafter, the reaction mixture was cooled to room temperature, the resultant polymer was filtered off, washed with water and packaged moist. This produced 431 g of a moist monodisperse copolymer III having a solids fraction of 36% by weight. The particle size was 650 μm.

Process Step e)

Hydrolysis of the monodisperse, crosslinked, methyl acrylate copolymer III from process steps a-c) using sodium hydroxide

Saponification of the Copolymer III

178 g of deionized water and 380 g of the moist copolymer III (equivalent to 137 g dry) were charged in a 4 liter flat-flange vessel equipped with gate stirrer, temperature sensor and thermostat. The dispersion was brought to reflux with stirring (200 rpm) and 1176 g of 50% strength by weight NaOH solution were added in the course of 2 hours. In the course of 5 hours at reflux temperature, 300 ml of a methanol/water mixture distilled. Thereafter, the mixture was cooled to room temperature. The resin was washed with deionized water in a column until the pH was neutral. This produced 3500 ml of monodisperse, weakly acidic cation exchanger 2 in the sodium form.

Ion exchange of the weakly acidic cation exchanger 2

The 3500 ml of the moist monodisperse weakly acidic cation exchanger 2 in the sodium form were eluted with 6 litres of 6% strength by weight sulphuric acid in a column and subsequently washed with deionized water until the pH was neutral. This produced 1000 ml of monodisperse, weakly acidic cation exchanger 2 in the acid form having a water content of 72.5% by weight. The mean particle size was 980 μm, Ø(90)/Ø(10) was 1.48. The total capacity of the resin was 2.05 mol/l.

Test Methods:

Determination of the Total Capacity of the Resin

55 ml of exchanger in the as-delivered form were shaken in a 100 ml measuring cylinder under demineralized water on a vibrating bench and flushed into a filter tube. 300 ml of 15% strength hydrochloric acid were added in the course of 60 minutes. Subsequently, the resin was washed with deionized water until the eluate is neutral. Of the resin, 50 ml were shaken and flushed into a filter tube. 600 ml of 1 normal sodium hydroxide solution were added in the course of 60 minutes and the eluate was collected in a 1 liter Erlenmeyer flask. The resin was washed with 200 ml of deionized water, the eluate likewise being collected in the 1 liter Erlenmeyer flask. The Erlenmeyer flask was made up to the mark with demineralized water and mixed. 50 ml of solution were diluted in a glass beaker with 50 ml of demineralized water and titrated using 0.1 N hydrochloric acid to pH 4.3 using a pH electrode.

Total capacity (TC): the total capacity is a measure of the amount of acid groups in the resin.

Dimension: mol of acid groups per litre of resin

Determination of TC
(30−consumption)/2.5=mol/litre of resin in the acid form

1. A process for producing a monodisperse cation exchanger of the poly(meth)acrylic acid type, comprising:
a) preparing a monodisperse, crosslinked bead polymer a seed,
b) admixing the monodisperse crosslinked bead polymer with at least one (meth)acrylic monomers, at least one crosslinkers, and an initiators, thereby forming a mixture of swollen monodisperse crosslinked bead polymer and the (meth)acrylic monomers,
c) polymerizing the (meth)acrylic monomer at elevated temperature, thereby forming a monodisperse crosslinked (meth)acrylic bead polymer, and
d) hydrolyzing the monodisperse, crosslinked (meth)acrylic bead polymer with an acid or an aklalis.

2. The process according to claim 1, wherein the monodisperse crosslinked bead polymer prepared in process step a) is produced by a combination of atomization (jetting) and polymerization.

3. The process according to claim 1, wherein the monodisperse crosslinked bead polymer prepared in process step a) is produced by a seed-feed process.

4. The process according to claim 1, wherein the monodisperse crosslinked bead polymer prepared in process step a) is produced by fractionating a heterodisperse crosslinked bead polymer.

5. The process according to claim 2, wherein the monodisperse crosslinked bead polymer is microencapsulated by a complex coacervate.

6. The process according to claim 1, wherein the monodisperse crosslinked bead polymer contains polymerized units of styrene, divinylbenzene and ethylvinylbenzene.

7. The process according to claim 1, wherein the(meth)acrylic monomer is methyl acrylate, methyl methacrylate, acrylic acid, methacrylic acid, acrylonitrile, methacrylonitrile, or a combination thereof.

8. The process according to claim 1, wherein said crosslinker is divinylbenzene, divinyltoluene, trivinylbenzene, diethylene glycol divinyl ether, triethylene glycol divinyl ether, tetraethylene glycol divinyl ether, butanediol divinyl ether, ethylene glycol divinyl ether, cyclohexanedimethanol divinyl ether, hexanediol divinyl ether, trimethylolpropane trivinyl ether, or a combination thereof.

9. The process according to claim 1, wherein methyl isobutyl ketone, hexane, cyclohexane, octane, isoootane, isododecane, n-butanol, 2-butanol, isobutanol, t-butanol, octanol, or a combination thereof, are added to the (meth)acrylic monomers as porogen.

10. A monodisperse cation exchanger of the poly(meth)acrylic acid type obtained by;
a) preparing a monodisperse, crosslinked bead polymer as a seed,
b) admixing the monodisperse crosslinked bead polymer with at least one (meth)acrylic monomers, at least one crosslinker, and an initiators, thereby forming a mixture of swollen monodisperse crosslinked bead and the (meth)acrylic monomers,
c) polymerizing the (meth)acrylic monomers at elevated temperature, thereby forming a monodisperse crosslinked (meth)acrylic bead polymer, and
d) hydrolysing the monodisperse crosslinked (meth)acrylic bead polymer with an acids or an alkalis.

11. The monodisperse cation exchanger of the poly(meth)acrylic acid type according to claim 10, wherein the ratio of the 90% value (Ø(90)) and the 10% value (Ø(10)) of the volume distribution, Ø(90)/Ø(10), is less than or equal to 1.25.

12. The monodisperse cation exchanger of the poly(meth)acrylic acid type according to claim 10, wherein a porogen is used.

13. A process for removing cations, dye particles or organic components from aqueous or organic solutions, comprising; contacting said aqueous or organic solution with the monodisperse cation exchanger of the poly(meth)acrylic acid type according to claim 10.

14. A process for softening in the neutral exchange of aqueous or organic solutions, comprising: contacting said aqueous or organic solution with the monodisperse cation exchanger of the poly(meth)acrylic acid type according to claim 10.

15. A process for purifying waters of the chemicals industry, the electronics industry and from power stations, comprising: contacting said waters with the monodisperse cation exchanger of the poly(meth)acrylic acid type according to claim 10.

16. A process for decolorizing and desalting of wheys, thin gelatin broths, fruit juices, fruit musts and aqueous solutions of sugars, comprising: contacting said wheys, thin gelatin broths, fruit juices, fruit musts and aqueous solutions of sugars with the monodisperse cation exchanger of the poly(meth)acrylic acid type according to claim 10.

17. A process for separating off and purifying biologically active components, including antibiotics, enzymes, peptides and nucleic acids from their solutions, including reaction mixtures and fermentation broths, comprising: contacting said biologically active components with the monodisperse cation exchanger of the poly(meth)acrylic acid type according to claim 10.
